(19) United States
(12) Patent Application Publication
(10) Pub. No.: US 2012/0161507 A1
(43) Pub. Date: Jun. 28, 2012

(54) Method for Operating a Hydraulic Vehicle Braking System

(75) Inventors: Herbert Vollert, Vaihingen/Enz (DE); Remy Gaarnier, Remseck (DE); Reinhard Weiberle, Vaihingen/Enz (DE); Time Jahnz, Besigheim (DE); Volker Mehl, Weingarten (DE); Frank Kneip, Bruchenishelbad/Hiesau (DE); Dirk Mahnkopf, Egloshem (DE); Jens Kolarsky, Bietigheim/Bissingen (DE); Stephan Hoenle, Korntal-Muenchingen (DE)

(73) Assignee: ROBERT BOSCH GMBH, STUTTGART (DE)

(21) Appl. No.: 13/148,860

(22) PCT Filed: Dec. 14, 2009
(86) PCT No.: PCT/EP09/67074

§ 371 Date: Mar. 5, 2012

(30) Foreign Application Priority Data
Feb. 11, 2009 (DE) 10 2009 000 769.5

(51) Int. Cl. B60T 13/128; B60T 8/44

(52) U.S. Cl. 303/114.1; 188/355

(57) ABSTRACT

A method for operating a hydraulic vehicle braking system having an electromechanical brake booster is disclosed. A shut-off valve that is located between a brake master cylinder and wheel brakes is closed to maintain a wheel-brake pressure and thus a braking force. To maintain a constant braking force, no current must be applied to an electric motor of the brake booster. The vehicle braking system can be used as a parking brake. The shut-off valve is present if the vehicle braking system has an anti-lock control device.

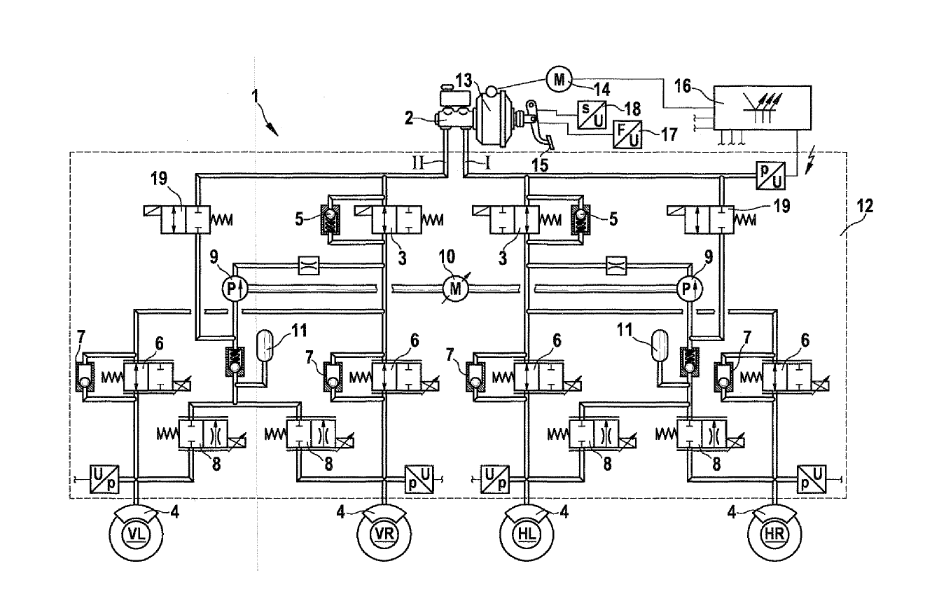

### PRIOR ART

The invention relates to a method for operating a hydraulic vehicle braking system which has a brake master cylinder with an electromechanical brake booster, having the features of the pre-characterizing clause of claim 1.

German Laid-Open Application DE 103 27 553 A1 has disclosed a hydraulic vehicle braking system of this kind which is of conventional construction apart from the brake booster. The vehicle braking system has a dual-circuit brake master cylinder, to which four wheel brakes, divided into two brake circuits, are connected. A dual-circuit vehicle braking system is not obligatory for the invention, nor is the number of brake circuits or wheel brakes. Moreover, the known vehicle braking system has a wheel slip control device, for which names such as anti-lock (braking), anti-slip regulation, vehicle dynamics and/or stability control system and abbreviations such as ABS, ASR, FDR and ESP are in common use. The hydraulic part of the wheel slip control device comprises a brake pressure buildup valve and a brake pressure reduction valve for each wheel brake, and, for each brake circuit, has a hydraulic pump, an isolation valve, by means of which the brake master cylinder can be isolated hydraulically from the brake circuit, and an intake valve, by means of which the brake master cylinder can be connected to a suction side of the hydraulic pump for the purpose of rapid brake pressure buildup. Such wheel slip control devices and their operation are known per se and will not be explained in detail here.

Instead of a vacuum brake booster, the known vehicle braking system has an electromechanical brake booster with a hollow-shaft electric motor, the rotor of which has a nut of a spindle drive, which converts the rotary drive motion of the electric motor into a translatory motion for the actuation of the brake master cylinder. Other designs of electromechanical brake booster are possible for the invention, it being possible, for example, for the brake booster to have a rack mechanism, if appropriate with a worm for driving the rack, for converting the rotary drive motion of an electric motor into a translatory motion for actuation of the brake master cylinder. It is also possible for an electromechanical brake booster with a linear motor, an electromagnet or a piezo element to be used for the method according to the invention. This list is not exhaustive.

The vehicle braking system is a power-assisted braking system, i.e. an actuating force for actuation of the brake master cylinder is supplied in part as a muscular force by a vehicle driver and the rest is supplied as an independent force by the electromechanical brake booster. Operation as an independently powered braking system, in which the actuating force is produced exclusively as an independent force by the brake booster and a muscular force exerted by a vehicle driver for brake actuation or alternatively an actuating displacement carried out by the vehicle driver is used as a setpoint variable for open-loop or closed-loop control of the brake booster force, referred to as the independent force, is also conceivable.

### DISCLOSURE OF THE INVENTION

The method according to the invention, having the features of claim 1, envisages closing a valve referred to here as an isolation valve, which is located between the brake master cylinder and the at least one wheel brake of the vehicle braking system, to maintain a wheel-brake pressure prevailing in the at least one wheel brake and hence to maintain a braking force. It is thereby possible to maintain an applied braking force without the need to supply the electromechanical brake booster with current. As a result, the brake booster is relieved of thermal stress and the electric load on an on-board electrical system of a vehicle is reduced.

The subclaims relate to advantageous embodiments and developments of the invention indicated in claim 1.

Claim 2 envisages an immobilization brake function, which is also referred to as a parking brake function. The isolation valve is closed only when the vehicle is at a standstill and, in accordance with the development in claim 3, if there is a parking brake pressure in the vehicle braking system. The parking brake pressure is the hydraulic pressure that is necessary and sufficient to hold the stationary vehicle at a standstill, even on an uphill or a downhill slope. The vehicle is thereby held at a standstill, even when it is parked on an incline. The parking brake pressure required for this purpose depends, inter alia, on the vehicle, especially the weight thereof, the vehicle braking system itself and possibly also on variable parameters such as the temperature of the at least one wheel brake. The vehicle braking system can be used as an immobilization braking system without the need to supply current to the electromechanical brake booster in order to maintain a braking force.

Claim 4 envisages using the existing isolation valves of a wheel slip control device, thus eliminating the need for any additional expenditure on construction and assembly. In the case of a multi-circuit vehicle braking system, the isolation valves can be closed in all the brake circuits, some of the brake circuits or one brake circuit to maintain the wheel brake pressure. In the case of a vehicle braking system without isolation valves, that is to say especially without a wheel slip control device, at least one valve must be provided as an isolation valve between the brake master cylinder and the at least one wheel brake.

### BRIEF DESCRIPTION OF THE DRAWING

The invention is explained in greater detail below with reference to an embodiment illustrated in the drawing. The single FIGURE shows a hydraulic circuit diagram of a hydraulic vehicle braking system for carrying out the method according to the invention.

### EMBODIMENT OF THE INVENTION

The hydraulic vehicle braking system 1 according to the invention, which is illustrated in the drawing, has a slip control device 12 (anti-lock braking system ABS; anti-slip regulation system ASR; vehicle dynamics control system FDR, ESP). It is designed as a dual-circuit braking system with two brake circuits I, II, which is connected to a brake master cylinder 2. Each brake circuit I, II is connected to the brake master cylinder 2 via an isolation valve 3. In their deenergized home position, the isolation valves 3 are open 2/2-way solenoid valves. Respective nonreturn valves 5, which allow flow from the brake master cylinder 2 to wheel brakes 4, are connected hydraulically in parallel with the isolation valves 3. The wheel brakes 4 are connected to the isolation valve of each brake circuit I, II via brake pressure buildup valves 6. In their deenergized home position, the brake pressure buildup valves 6 are open 2/2-way solenoid valves. Connected in parallel therewith are nonreturn valves 7, which allow flow from the wheel brakes 4 in the direction of the brake master cylinder 2.

Connected to each wheel brake 4 is a brake pressure reduction valve 8, said valves being connected jointly to a suction side of a hydraulic pump 9. The brake pressure reduction valves 8 are designed as 2/2-way solenoid valves that are closed in the deenergized home position thereof. A delivery side of the hydraulic pump 9 is connected between the brake pressure buildup valves 6 and the isolation valves 3, i.e. the delivery side of the hydraulic pump 9 is connected to the wheel brakes 4 via the brake pressure buildup valves 6 and to the brake master cylinder 2 via the isolation valve 3. The brake pressure buildup valves 6 and the brake pressure reduction valves 8 are proportional valves, since these allow better open-loop and closed-loop control.

Each of the two brake circuits I, II has a hydraulic pump 9, said pumps being jointly drivable by an electric motor 10. The suction sides of the hydraulic pumps 9 are connected to the brake pressure reduction valves 8. On the suction side of the hydraulic pumps 9 there are hydraulic accumulators 11 for receiving and temporarily storing brake fluid flowing out of the wheel brakes 4 during slip control due to the opening of the brake pressure reduction valves 8.

The brake pressure buildup valves 6 and the brake pressure reduction valves 8 form wheel brake pressure modulation valve arrangements, by means of which brake pressure control at each individual wheel can be carried out in a manner known per se that does not require explanation here to give wheel slip control, while the hydraulic pump 9 is being driven. During wheel slip control, the isolation valves 3 are closed, i.e. the vehicle braking system 1 is isolated hydraulically from the brake master cylinder 2.

By means of an intake valve 19 in each brake circuit I, II, the suction side of the hydraulic pump 9 can be connected to the brake master cylinder 2. In their deenergized home position, the intake valves 19 are closed 2/2-way solenoid valves. When they are opened, the hydraulic pump 9 draws brake fluid directly from the brake master cylinder 2, and, as a result, a more rapid brake pressure buildup is possible with the hydraulic pump 9 when the brake master cylinder 2 is unactuated and the vehicle braking system 1 is depressurized.

The brake master cylinder 2 has an electromechanical brake booster 13, which, with the aid of an electric motor 14, produces an independent force that, together with a muscular force applied via a brake pedal 15, actuates the brake master cylinder 2. The electric motor 14, which is illustrated symbolically, is integrated into the brake booster 13. The electric motor 14 can be a rotary motor, the rotary motion of which is stepped down by means of a transmission and converted into a translatory motion for actuating the brake master cylinder 2. An embodiment of the brake booster 13 with an electric linear motor or an electromagnet is also possible. This list is not exhaustive.

For open-loop or closed-loop control of the vehicle braking system 1 including the brake booster 13, there is an electronic control unit 16. A pedal force exerted on the brake pedal 15 can be measured by means of a force sensor 17, and a position of the brake pedal 15 can be measured by means of a displacement sensor 18.

In accordance with the method according to the invention, the isolation valves 3 are closed when the vehicle braking system 1 is actuated in order to maintain a wheel brake pressure built up by actuating the brake master cylinder 2 and hence to maintain a braking force of the vehicle braking system 1 without the need to supply current to the electric motor 14 of the brake booster 13. The electric motor 14 is relieved of thermal stress and a current load on an on-board electrical system of a motor vehicle fitted with the vehicle braking system 1 is reduced. If the vehicle braking system 1 has the wheel slip control device 12 described, the isolation valves 3 are present, and therefore the method according to the invention does not require any additional components but uses the existing isolation valves 3.

The method according to the invention can be used to hold constant a braking force applied by actuating the brake master cylinder 2, when descending a hill for example, without the need to supply current to the electric motor 14 of the brake booster 13. The use of the method according to the invention for an immobilization brake function, which is often also referred to as a parking brake function, is also possible, in other words to hold a stationary motor vehicle equipped with the vehicle braking system 1 at a standstill: when the vehicle is at a standstill, the isolation valves 3 are closed. In particular, the isolation valves 3 are closed when a parking brake pressure has been built up by actuating the brake master cylinder 2. The parking brake pressure is a hydraulic pressure prevailing in the vehicle braking system 1, more particularly in the wheel brakes 4, which is sufficient to hold the vehicle at a standstill, even when the vehicle is parked on an incline. Apart from being built up by power-assisted actuation, in which the brake pedal 15 is pressed by a vehicle driver using muscular force and a force referred to as an independent force is additionally exerted on the brake master cylinder 2 by the brake booster 13, the parking brake pressure for the immobilization brake function can also be built up by independent force, i.e. exclusively by means of the brake booster 13 and without actuation of the brake pedal 15. It is also possible to close just one of the two isolation valves 3, the result being that the immobilization brake function acts only on the wheels of one of the two brake circuits I, II; this applies not only to the immobilization brake function but is also possible in the case of a service braking operation.

1. A method, comprising operating a hydraulic vehicle braking system which has a brake master cylinder with an electromechanical brake booster, at least one hydraulic wheel brake, which is connected to the brake master cylinder, and an isolation valve, which is located between the brake master cylinder and the wheel brake, wherein the isolation valve is closed to maintain a wheel-brake pressure.

2. The method as claimed in claim 1, wherein the isolation valve is closed only when the vehicle is at a standstill.

3. The method as claimed in claim 2, wherein the isolation valve is closed only if there is a parking brake pressure in the vehicle braking system.

4. The method as claimed in claim 1, wherein the vehicle braking system has a wheel slip control device, which has the isolation valve.
